(19) United States
(12) Patent Application Publication
(10) Pub. No.: US 2016/0277808 A1
(43) Pub. Date: Sep. 22, 2016

(54) SYSTEM AND METHOD FOR INTERACTIVE SECOND SCREEN

(71) Applicants: Lei Yu, Hangzhou (CN); Yangbin Wang, Palo Alto, CA (US)

(72) Inventors: Lei Yu, Hangzhou (CN); Yangbin Wang, Palo Alto, CA (US)

(21) Appl. No.: 14/481,092

(22) Filed: Sep. 9, 2014

Related U.S. Application Data
(63) Continuation-in-part of application No. 13/204,870, filed on Aug. 8, 2011, now abandoned.

(51) Int. Cl. H04N 21/658; H04N 21/8352; H04N 21/4223; H04N 21/4722; H04N 21/41; H04N 21/414

(52) U.S. Cl. CPC H04N 21/6581; H04N 21/4126; H04N 21/41407; H04N 21/4223; H04N 21/4722; H04N 21/8352

(57) ABSTRACT

A method and system for interactive second screen comprises the steps of capturing audio, video or image information from the primary screen via sensors built with the secondary screen device; ingesting and collecting VDNA (Video DNA) fingerprints of the captured media information in the secondary screen device; sending the ingested fingerprints along with other information such as metadata, user's location, etc, to the content identification server via Internet or mobile networks; providing content-aware information or resources back to the secondary screen device, and providing user interaction with the content-aware information and resources.

### CROSS-REFERENCE TO RELATED APPLICATIONS

The present application is a Continuation-in-Part of U.S. application Ser. No. 13/204,870, filed on Aug. 8, 2011, entitled “SYSTEM AND METHOD FOR INTERACTIVE SECOND SCREEN” and which is incorporated herein by reference and for all purposes.

### BACKGROUND OF THE INVENTION

1. Field of the Invention

The present invention relates to a method and system for providing extra information and resources regarding the media content playing on the primary screens via a second screen device, which comprises the steps of 1) capturing audio, video or image information from the primary screen via sensors built with the secondary screen device, 2) extracting and collecting VDNA (Video DNA) fingerprints of the captured media information in the secondary screen device, 3) sending the extracted fingerprints along with other information's such as metadata, user's location, etc., to the content identification server via Internet or mobile networks, 4) server-side content identification and providing content-aware information or resources back to the secondary screen device, and 5) user interaction with the content-aware information and resources. Specifically, the present invention relates to facilitating additional rich media experiences for the users watching or listening to media contents on the primary screens such as TV (television) sets or projectors, which come with few or none interactive functionalities.

2. Description of the Related Art

Interactive television represents a continuum from low interactivity (TV on/off, volume, changing channels) to moderate interactivity (simple movies on demand without player controls) and high interactivity in which, for example, an audience member affects the program being watched. The most obvious example of this would be any kind of real-time voting on the screen, in which audience votes create decisions that are reflected in how the show continues. A return path to the program provider is not necessary to have an interactive program experience. Once a movie is downloaded for example, controls may all be local. The link was needed to download the program, but texts and software, which can be executed locally at the set-top box, or IRD (Integrated Receiver Decoder) may occur automatically, once the viewer enters the channel.

To be truly interactive, the viewer must be able to alter the viewing experience, or return information to the broadcaster. This “return path”, “return channel” or “back channel” can be by telephone, mobile SMS (short message service), radio, asymmetric digital subscriber lines (ADSL) or cable. Cable TV viewers receive their programs via a cable, and in the integrated cable return path enabled platforms, they use the same cable as a return path. Satellite viewers (mostly) return information to the broadcaster via their regular telephone lines.

They are charged for this service on their regular telephone bill. An Internet connection via ADSL, or other, data communications technology, is also being increasingly used. Increasingly the return path is becoming a broadband IP connection, and some hybrid receivers are now capable of displaying video from either the IP connection or from traditional tuners. Some devices are now dedicated to displaying video only from the IP channel, which has given rise to IPTV—Internet Protocol Television. The rise of the “broadband return path” has given new relevance to Interactive TV, as it opens up the need to interact with Video on Demand servers, advertisers, and web site operators.

Nowadays most methods to implement interactive television require only the primary screen, a set-top box and a remote controller. Wherein the primary screen devices are those devices on which users enjoy media contents such as TV series, movies, live shows, etc., via cable network or broadcasting, for example TV sets, or projectors. The media contents are always transmitted in real-time. Conventional user interactions with content provider via primary screen devices are very limited, including: 1) product promotion codes or phone numbers are printed as banners displaying at the corners of the primary screen; 2) surrounding information such as content metadata or relevant contents are displayed as banners at the corners of the primary screens; 3) users make phone calls or text SMS to content providers to order or bid products, for example TV shopping programs; 4) users make phone calls or text SMS to vote, for example live shows or competitions.

The simplest, Interactivity with a TV set is already very common, starting with the use of the remote control to enable channel surfing behaviors, and evolving to include video-on-demand, VCR (video cassette recorder)-like pause, rewind, and fast forward, and DVRs (digital video recorder), commercial skipping and the like. It does not change any content or its inherent linearity, only how users control the viewing of that content. DVRs allow users to time shift content in a way that is impractical with VHS (Video Home System). Though this form of interactive TV is not insignificant, critics claim that saying that using a remote control to turn TV sets on and off makes television interactive is like saying turning the pages of a book makes the book interactive. In the not too distant future, the questioning of what is real interaction with the TV will be difficult.

In its deepest sense, interactivity with TV program content is the one that is “interactive TV”, but it is also the most challenging to produce. This is the idea that the program itself might change based on viewer input. Advanced forms, which still have uncertain prospect for becoming mainstream, include dramas where viewers get to choose or influence plot details and endings.

The reasons why the conventional primary screen devices have limited interaction methods are 1) they were originally designed to play video, audio or image contents; 2) the only interactive facility for most of the primary screen devices is the remote controller, which provides control instructions to the playback status of the primary screen; 3) many of the primary screen devices are connected to TV cables or broadcasting networks only; 4) even if they are connected to the Internet, dedicated information or interactive resources for the media contents are seldom found.

Therefore there are some disadvantages on the current ways of interactions between users and the primary screen devices: 1) limited ways to achieve real-time interactions between users and content providers; 2) product promotion or program banners are redundant information blocking the perspective on the primary screen; 3) content providers need to deploy a lot of human resources to receive phone calls; 4) interactions triggered by phone calls or text SMS are difficult to be real-time.

Recently, some primary screen devices are equipped with more Internet interactions such as smart TVs. However, a lot of deployment efforts are needed to setup the whole eco-system based on smart primary screen devices. Presently speaking, users using conventional primary screen devices are the majority.

Ways to adapt to the conventional primary screen devices and provide real-time information and interactive resources between users and content providers are hence desirable, so that no or few human operations are involved in the whole process. With the concept of second screen devices and the help from a mature media fingerprinting technology, capturing required content and metadata from primary screens, the system is able to identify any number or format of media contents playing on the primary screen, and push content-aware real-time information and interactive resources which content providers and users desire.

### SUMMARY OF THE INVENTION

An object of the invention is to overcome at least some of the drawbacks relating to the prior arts as mentioned above.

Conventional ways to interact with primary screens such as TV are very limited, for example using remote controller to control the playback of the media, or making phone calls or texting SMS to achieve some level of communication with content providers.

With the help of powerful second screen devices and media content identification technology, it is possible to allow resourceful and interesting interactions between audiences and content providers.

An object of the present invention is to adapt to the conventional primary screen devices and provide real-time information and interactive resources between users and content providers. The present invention comprises the steps of capturing audio, video or image information from the primary screen via sensors built with the secondary screen device, extracting and collecting VDNA fingerprints of the captured media information in the secondary screen device, sending the extracted fingerprints along with other information's such as metadata, user's location, etc., to the content identification server via internet or mobile networks, server-side content identification and providing content-aware information or resources back to the secondary screen device, and user interaction with the content-aware information and resources.

Interactive TV is often described by clever marketing gurus as “lean back” interaction, as users are typically relaxing in the living room environment with a remote control in one hand. This is a very simplistic definition of interactive television that is less and less descriptive of interactive television services that are in various stages of market introduction. This is in contrast to the similarly slick marketing devised descriptor of personal computer-oriented “lean forward” experience of a keyboard, mouse and monitor. This description is becoming more distracting than useful as video game users, for example, don't lean forward while they are playing video games on their television sets, a precursor to interactive TV. A more useful mechanism for categorizing the differences between PC and TV based user interaction is by measuring the distance the user is from the Device. Typically a TV viewer is “leaning back” in their sofa, using only a Remote Control as a means of interaction. While a PC user is 2 ft. or 3 ft. from his high-resolution screen using a mouse and keyboard. The demands of distance, and user input devices, require the application's look and feel to be designed differently. Thus Interactive TV applications are often designed for the “10 ft user experience” while PC applications and web pages are designed for the “3 ft user experience”. This style of interface design rather than the “lean back or lean forward” model is what truly distinguishes Interactive TV from the web or PC. However even this mechanism is changing because there is at least one web-based service which allows you to watch Internet television on a PC with a wireless remote control.

In the case of second screen solutions Interactive TV, the distinctions of “lean-back” and “lean-forward” interaction become more and more indistinguishable. There has been a growing proclivity to media multitasking, in which multiple media devices are used simultaneously (especially among younger viewers). This has increased interest in two-screen services, and is creating a new level of multitasking in interactive TV. In addition, video is now ubiquitous on the web, so research can now be done to see if there is anything left to the notion of “lean back” “versus” “lean forward” uses of interactive television.

A second screen is a complementary interactive facility to a device, which has a primary screen able to play media contents such as TV, sets, projectors etc. The second screen device has no physical relationship to the primary screen device, yet it helps to display surrounding information about the content that is playing on the primary screen device and provides real-time interactive options according to the media content. Typical examples of second screen devices can be mobile handhelds such as smart phones, or tablets. Basic requirements of second screen devices include: 1) network enabled, 2) able to install dedicated applications or plugins, 3) equipped with input sensors such as cameras, microphones, GPS (global position system) receivers, and so on 4) equipped with screen where additional information and interactive resources displays, 4) equipped with user input facilities such as hardware keys or touch screens.

The information captured from the media content which playing on the primary screen can be video, audio or even image, as long as such information can be extracted into VDNA fingerprints and identified. Hence multiple sensors on the second screen devices can be functioning together to achieve this. It means that the type of contents sent to identify can be combination of different formats, for example using the combination of audio and images captured from the media content playing on the primary screen to generate identification results and other information. Users can also choose the types of sensors on the second screen device to capture information.

Extracting and collecting fingerprints out from the captured contents on the second screen devices takes advantage of the higher and higher processing speed of the mobile devices nowadays to extract characteristic values of each frame of image and audio from media contents, as is called “VDNA”, which are registered in VDDB (Video Digital Data-Base) of the identification server for reference and query. Such process is similar to collecting and recording human fingerprints. One of the remarkable usages of VDNA technology is to rapidly and accurately identify media contents, so that it is possible to identify contents and send surrounding information and interactive resources in real-time when users are watching contents on the primary screen.

Another characteristic of VDNA fingerprints is that it is very compact, so that it is feasible to transfer over mobile networks. Because some terminals may use mobile networks and they always have lower bandwidth, sending huge amount of information of the captured media content to the content provide for identification is not realistic. Therefore extracting key characteristics of the media contents and sending the extracted fingerprints of the media contents remits the mentioned disadvantages.

The VDNA fingerprint process is performed on the second screen devices where media contents are captured, therefore additional software components are required to install on these devices, such as dedicated application for mobile devices and tablets. These software components help to collect fingerprints of the on play media contents as well as other metadata information and user specific data. Such data will be sent via Internet or mobile networks to content identification server, where the media content can be identified.

The server provides content-aware surrounding information and resources based on the identified content. This information includes product-promoting advertisements, information about relevant contents, interactive quiz or small games, interactive votes, and much more. This real-time information has strong relationship with the media contents playing on user's primary screen; users can perform various actions on their second screen devices according to their interests.

In summary, the present invention takes advantage of the properties of computers, modern mobile devices and networks: high speed, automatic, huge capacity and persistent, and identifies media contents in very high efficiency, makes it possible for content providers to automatically, accurately and rapidly push relevant content-aware surrounding information and interactive resources to the second screen devices.

In other aspect, the present invention also provides a system and a set of methods with features and advantages corresponding to those discussed above.

All these and other introductions of the present invention will become much clear when the drawings as well as the detailed descriptions are taken into consideration.

### BRIEF DESCRIPTION OF THE DRAWINGS

For the full understanding of the nature of the present invention, reference should be made to the following detailed descriptions with the accompanying drawings in which:

FIG. 1 shows schematically a component diagram of each functional entity in the system according to the present invention.

FIG. 2 is a flow chart showing a number of steps of the present invention on both device and server sides.

FIG. 3 is a flow chart showing the resources push methods between device and server sides.

FIG. 4 is a list of utilities enabled by second screen devices.

FIG. 5 shows the difference between the U.S. Pat. No. 8,009,861, PUBLICATION NO. 2007-0253594 by LU, et al and the present invention.

Like reference numerals refer to like parts throughout the several views of the drawings.

### DESCRIPTION OF THE PREFERRED EMBODIMENT

The present invention now will be described more fully hereinafter with reference to the accompanying drawings, in which some examples of the embodiments of the present inventions are shown. Indeed, these inventions may be embodied in many different forms and should not be construed as limited to the embodiments set forth herein; rather, these embodiments are provided by way of example so that this disclosure will satisfy applicable legal requirements. Like numbers refer to like elements throughout.

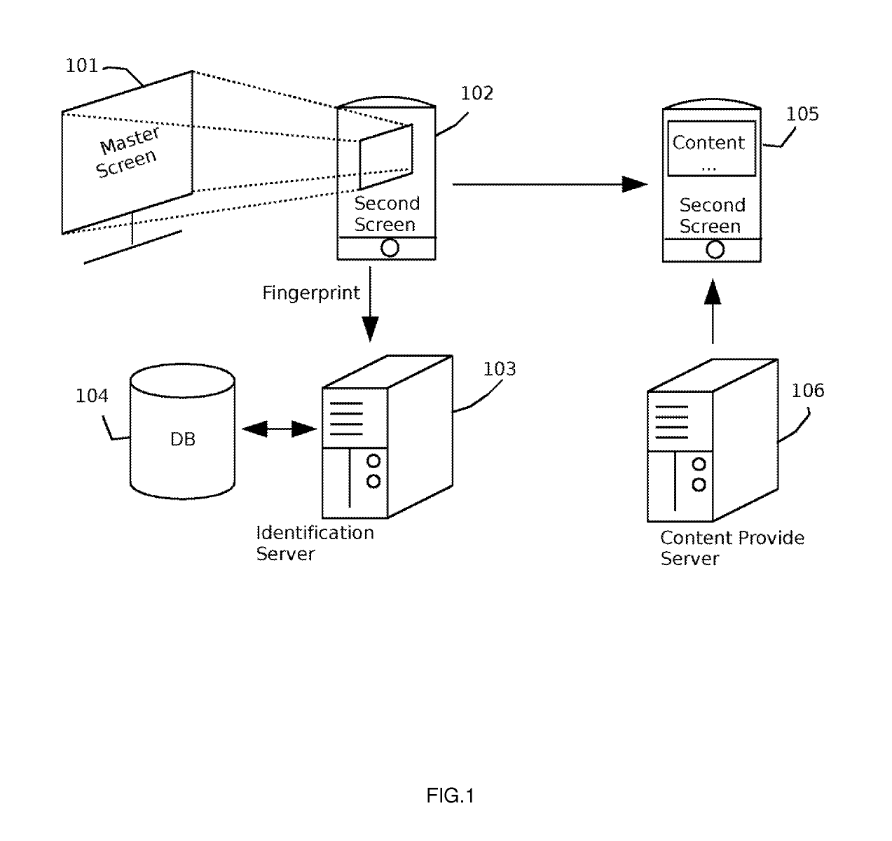

FIG. 1 illustrates main functional components of the second screen system, in which component 101 represents the primary screen or master screen device, where users enjoy media contents such as TV series, movies, live shows, etc., via cable network or broadcasting. The media contents playing on primary devices are always transmitted in real-time. Examples of primary screen devices are TV sets, or projectors.

The primary screen can offer limited user interactive functionalities with remote controller. The simplest, Interactivity with a TV set is already very common, starting with the use of the remote control to enable channel surfing behaviors, and evolving to include video-on-demand, VCR-like pause, rewind, and fast forward, and DVRs, commercial skipping and the like. It does not change any content or its inherent linearity, only how users control the viewing of that content. DVRs allow users to time shift content in a way that is impractical with VHS. Though this form of interactive TV is not insignificant, critics claim that saying that using a remote control to turn TV sets on and off makes television interactive is like saying turning the pages of a book makes the book interactive.

Interactive TV is often described by clever marketing gurus as “lean back” interaction, as users are typically relaxing in the living room environment with a remote control in one hand. This is a very simplistic definition of interactive television that is less and less descriptive of interactive television services that are in various stages of market introduction. This is in contrast to the similarly slick marketing devised descriptor of personal computer-oriented “lean forward” experience of a keyboard, mouse and monitor. This description is becoming more distracting than useful as video game users, for example, don't lean forward while they are playing video games on their television sets, a precursor to interactive TV. A more useful mechanism for categorizing the differences between PC and TV based user interaction is by measuring the distance the user is from the Device. Typically a TV viewer is “leaning back” in their sofa, using only a Remote Control as a means of interaction. While a PC user is 2 ft. or 3 ft. from his high-resolution screen using a mouse and keyboard. The demands of distance, and user input devices, require the application's look and feel to be designed differently. Thus Interactive TV applications are often designed for the “10 ft user experience” while PC applications and web pages are designed for the “3 ft user experience”. This style of interface design rather than the “lean back or lean forward” model is what truly distinguishes Interactive TV from the web or PC. However even this mechanism is changing because there is at least one web-based service which allows you to watch Internet television on a PC with a wireless remote control.

In the case of second screen solutions Interactive TV, the distinctions of “lean-back” and “lean-forward” interaction become more and more indistinguishable. There has been a growing proclivity to media multitasking, in which multiple media devices are used simultaneously (especially among younger viewers). This has increased interest in two-screen services, and is creating a new level of multitasking in interactive TV. In addition, video is now ubiquitous on the web, so research can now be done to see if there is anything left to the notion of “lean back” “versus” “lean forward” uses of interactive television.

A second screen is a complementary interactive facility to a device, which has a primary screen able to play media contents such as TV, sets, projectors etc. The second screen device has no physical relationship to the primary screen device, yet it captures media contents from primary screen devices, helps to identify the media contents and display surrounding information about the content that is playing on the primary screen device and provides real-time interactive options according to the media content. Typical examples of second screen devices can be mobile handhelds such as smart phones, or tablets.

Component 102 represents the action when second screen device is capturing media contents from the primary screen device. The information captured from the media content which playing on the primary screen can be video, audio or even image, as long as such information can be extracted into VDNA fingerprints and identified.

Therefore the second screen devices can use all available built-in sensors or even external sensors to achieve this. Second screen devices can be mobile handhelds such as smart phones, or tablets. Basic requirements of second screen devices include: 1) network enabled, 2) able to install dedicated applications or plugins, 3) equipped with input sensors such as cameras, microphones, GPS receivers, and so on 4) equipped with screen where additional information and interactive resources displays, 4) equipped with user input facilities such as hardware keys or touch screens.

Dedicated software components are installed on second screen devices, which coordinate the main tasks of the second screen devices, including a) capturing audio, video or images from primary screen via sensors, b) extract VDNA fingerprints of the media content while capturing, c) collect required broadcasting information, d) transfer all the data to backend servers, e) response to the media content related rich media resources feedback by backend server after content identification.

VDNA fingerprints data are extracted from the captured media contents by the dedicated software component installed on second screen devices. VDNA fingerprint is the essence of media content identification technology, it extracts the characteristic values of each frame of image or audio from media contents. Such process is similar to collecting and recording human fingerprints. Due to the fact that VDNA technology is entirely based on the media content itself that means in between media content and generated VDNA there is a one-to-one mapping relationship. Compared to the conventional method of using digital watermark technology to identify video contents, VDNA technology does not require pre-processing the video content to embed watermark information. Also the VDNA extraction algorithm is greatly optimized to be efficient, fast and lightweight so that it consumes only an acceptable amount of CPU (central processing unit) or memory resources on the terminal devices. The VDNA extraction process is performed on the terminal side very efficiently, and the extracted fingerprints are very small in size compared to the media content, which means a lot because it makes transferring fingerprints over network possible.

The VDNA extraction algorithm can be various. Take captured video content as an example, the extraction algorithm can be as simple as the following a) sample the video frame as image b) divide the input image into certain amount of equal sized squares, c) compute average value of the RGB (red, green and blue) values from each pixel in each square, d) in this case the VDNA fingerprint of this image is the 2 dimensional vector of the values from all divided squares. The smaller a square is divided, the more accuracy the fingerprint can achieve, yet at the same time it will consume more storage. In more complex version of the VDNA extraction algorithm, other factors such as brightness, alpha value of the image, image rotation, clipping or flipping of the screen, or even audio fingerprint values will be considered.

The software component on the terminal devices will also collects information from broadcasting channel distributing the media content and the users, such as channel name, time and duration of the broadcast, user's preferences and location etc. The software component on the second screen devices will also send the collected metadata to the identification server along with the extracted VDNA fingerprints, for generating proper feedback resources.

The VDNA fingerprints of the captured media contents are then sent to identification server (component 103) for content identification. The server performs content identification and matching (103) against the VDDB (104) server where master media contents are registered.

The content identification server accepts media content query requests, which comes along with extracted VDNA fingerprints of the input media content. The input media contents can be any format of audio, video or image contents, which in this case are processed by dedicated software component on the second screen devices, so that a set of VDNA fingerprints are extracted from the contents. Basically the content identification server is composed by a set of index engines, a set of query engines and a set of master sample databases. All of these components are distributed and capable to cooperate with each other.

The index engines or distributed index engines, store a key-value mapping where the keys are hashed VDNA fingerprints of the registered master media content and the values are the identifier of the registered master media content. When a query request is triggered, a set of VDNA fingerprints of the input media content is submitted. Then a pre-defined number of VDNA fingerprints are sampled from the submitted data. The sampled fingerprints are in turn hashed using the same algorithm as those registered VDNA fingerprints were hashed, and using these hashed sampled fingerprints to get the values in the registered mapping. Based on statistical research on the matching rates of key frames between input media contents and master media contents, it can be concluded that given only a set of sampled fingerprints extracted from the input media content, it is in highly possible to get a list of candidate matched master content ranked by hit rate of similarity. The output of index engine will be a list of identifiers of candidate media contents ranked by hit rate of similarity with sampled fingerprints of input media content.

And the query engine performs VDNA fingerprint level match between each one of VDNA fingerprints extracted from input media content and all VDNA fingerprints of every candidate media content output from index engine. There is also scalability requirement for the design of query engines the same as index engine, because the number of registered media contents by content owner may vary in different magnitude, the amount of registered VDNA fingerprints can be massive. In such condition, distributed query engines are also required to enforce computing capability of the system. The basic building block of VDNA fingerprint identification algorithm is calculation and compare of Hamming Distance of fingerprints between input and master media contents. A score will be given after comparing input media content with each one of top ranked media contents outputted by index server. A learning-capable mechanism will then help to decide whether or not the input media content is identified with reference to the identification score, media metadata, and identification history.

The result of content identification will be send together with those user specific information collected from the second screen device such as channel name, time and duration of the broadcast, user's preferences and location etc., to the content provider's server (106) for content-aware rich media generation.

Content provides will predefine some business rules for the choice of the content-aware rich media, which could be content-aware surrounding information, including product promoting advertisements, information about relevant contents or interactive resources such as interactive quiz or small games, interactive votes, and much more. The selected content-aware rich media will then send back to the second screen device (105), where users can perform various actions on their second screen devices according to their interests.

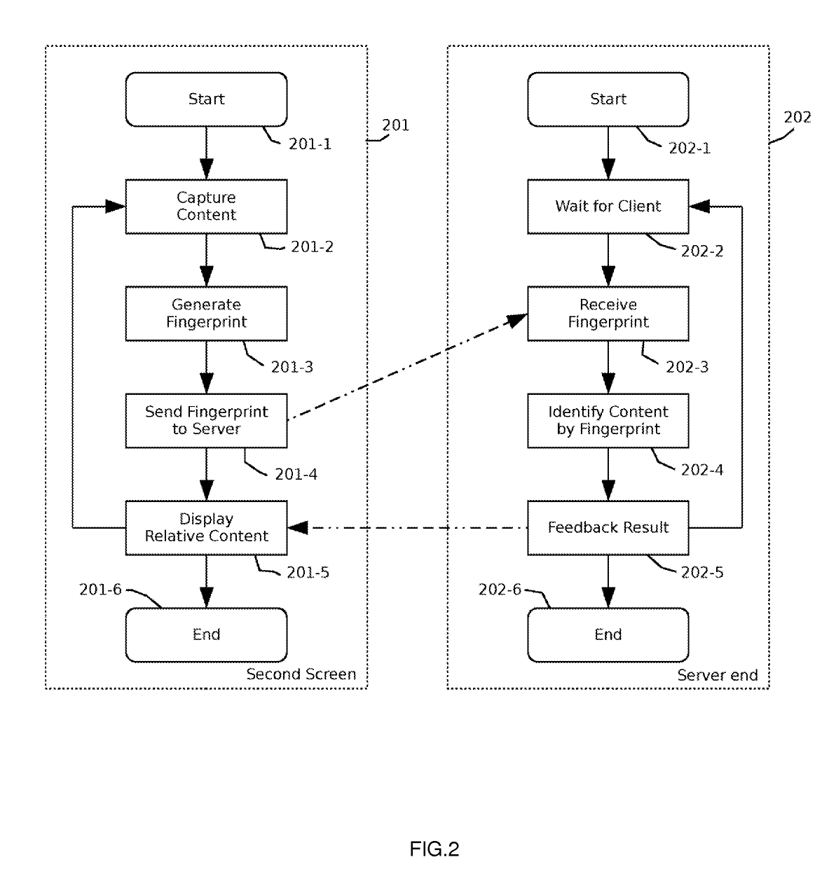

FIG. 2 illustrate the workflow on both second screen device and server sides, where group 201 represents the steps working on the second screen device, while group 202 represents the steps working on the server.

On the device side, the second screen device will start by capturing contents from the primary screen device. Users have the option to select which kinds of sensors are applied to capture data. The captured contents include video, audio or images, and they are immediately extracted into VDNA fingerprints on the second screen device (step 201-3). And then the device will send the VDNA fingerprints to the identification server along with other information acquired from the user such as user's location or preferences. After short time process of content identification in the server, selected content-aware surrounding information or interactive resources are sent from server, and will be displayed in predefined forms on the second screen device, so that users can interact with these contents as they are interested.

While on the server side, once the server receives identification requests from the clients, it will start identifying the VDNA fingerprints (202-4) comes with the request. The core-processing block of the content identification system is VDDB. After received VDNA fingerprints and media content metadata from the second screen device, VDDB starts a quick hash process over the sample VDNA fingerprints with index servers.

Based on statistical research on the matching rates of key frames between input media contents and master media contents, it can be concluded that given only a set of sampled fingerprints extracted from the input media content, it is in highly possible to get a list of candidate matched master content ranked by hit rate of similarity, if all master media contents are fingerprinted and indexed beforehand. This is the optimization idea behind index servers. Using index server to pre-process the input media content can save a lot of processing efforts by rapidly generating best matched media candidate list instead of thoroughly comparing every master media contents in detail at the first place.

Next step of content identification is inside the query engine, which performs VDNA fingerprint level match between each one of VDNA fingerprints extracted from input media content and all VDNA fingerprints of every candidate media content output from index engine. The basic building block of VDNA fingerprint identification algorithm is calculation and compare of Hamming Distance of fingerprints between input and master media contents. A score will be given after comparing input media content with each one of top ranked media contents outputted by index server. A learning-capable mechanism will then help to decide whether or not the input media content is identified with reference to the identification score, media metadata, and identification history. Finally the result will be used to generate content-aware rich media generation. Content provides will predefine some business rules for the choice of the content-aware rich media, which could be content-aware surrounding information, including product promoting advertisements, information about relevant contents or interactive resources such as interactive quiz or small games, interactive votes, and much more. The selected content-aware rich media will then send back (202-5) to the second screen device, where users can perform various actions on their second screen devices according to their interests.

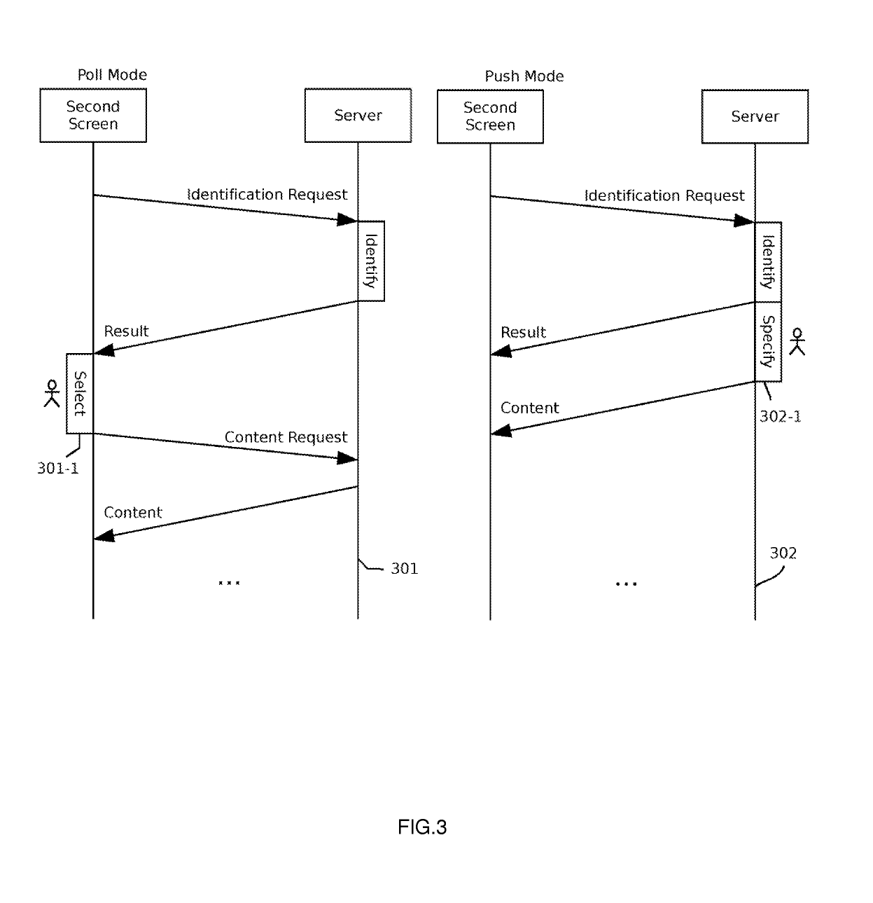

FIG. 3 illustrates alternative workflows that second screen devices may use to obtain content-aware information and interactive resources. The general purpose of both Poll Mode and Push Mode is to send VDNA fingerprints of the captured contents for identification, and get the resources generated by the server.

The difference is that in Poll Mode, after the content is identified, the result is sent back to the second screen device through designed protocol, and the second screen device can process the result and let the user to choose the kind of resources that he is interested, finally the selected kind of resources are polled from the server.

While in Push Mode, after the content is identified, the server will generate information or resources predefined by content provides, and such resources will be pushed to the users who's using second screen devices.

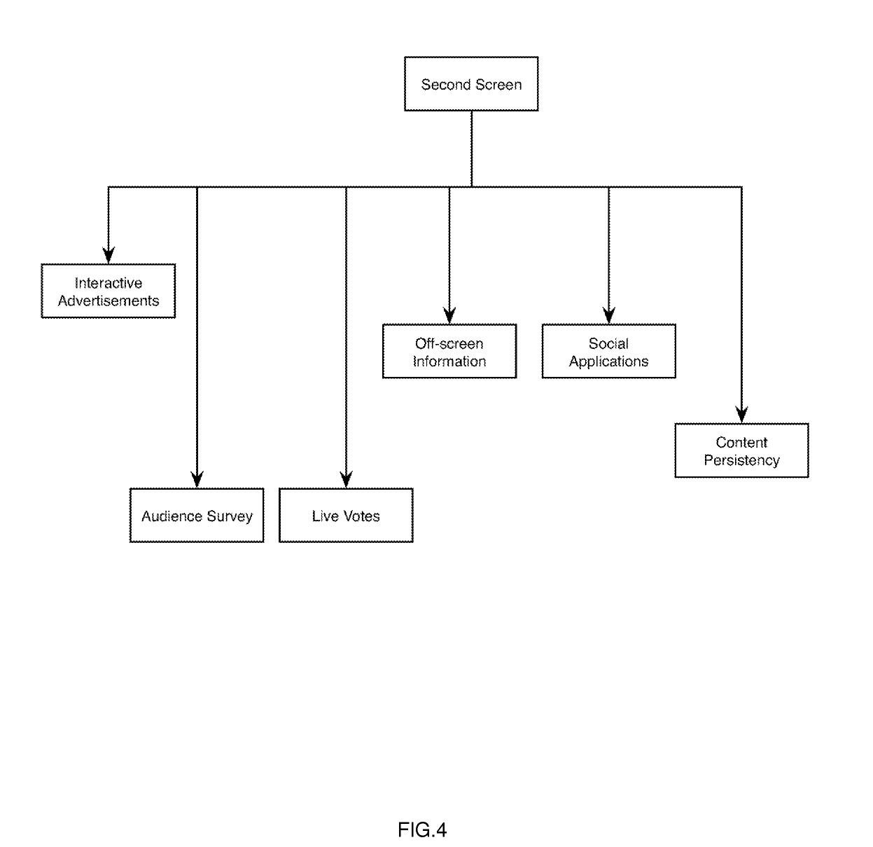

FIG. 4 lists some new user experiences that can be implemented with the invented Second Screen method and system. These new user experiences are not possible or very difficult to implement with the conventional way of interactions with primary screen.

Such new user experiences include:
1) Interactive advertisements, the conventional ways of displaying advertisements requires to either occupy the space on the primary screen (banner or block of advertisements are showing at the bottom or corners of the screen), or occupy the time when playing the content (advertisements that intervene in between the content). Besides such user-unfriendly ways of displaying advertisements, one more disadvantage is that they are not interactive or hardly interactive. Users need to pickup the phone only to dial the number that appears on the advertisement they are interested showing on primary screen, in very limited duration, because the number on the advertisement may disappear soon while other contents appear. With second screen technology, advertisements will be shown on the second screen. Because the second screen is kept posted of the media contents playing on the primary, the advertisements can also be content related. Also the second screen device can be a mobile phone or a tablet, which comes with a very powerful interactive interface. Users are able to do every possible kind of operations on the advertisements showing on the second screen device. And now the advertisements can have various forms like interactive animations, instead of those conventional banners.
2) Audience survey, the conventional way of collection surveys from the audience usually takes place after the show or the users finish watching the media content, and it always takes a lot of human works to collect surveys such as phone calls or build a website or send a lot of emails to ask the audience their opinions about the show. Now with the advantage of the feature of second screen, that is the information of it is in sync with the media content playing on the primary screen, content providers are able to push survey of the content to the audience who's watching it. The users can join these real-time surveys to submit their opinion about the media content they are watching, which are valuable to the content providers on their strategies on selection of media contents.
3) Live votes, the conventional way of collecting votes for a live show usually need to require the users to call a certain number, or SMS to a certain number, or maybe ask them to user their computer to vote online, but there are some time issues or other problems in this method, such as they just don't have enough human resources to answer phones. Now with the advantage of the feature from second screen, that is the information of it is in sync with the media content playing on the primary screen. Content providers can push voting options to their audience when they are broadcasting live shows. These interactive actions can leave the opportunities for the audience to vote for the changes or stages of the live show, so as to enhance their involvement of the show.
4) Off-screen information is referred to some metadata information about the media content playing on the primary screen, such as castings table of the movie. Conventionally these information will be listed after the show or a movie, but with second screen technology, because the second screen have the exact information of what content is playing on primary, users are able to query various information about the content in real-time.
5) Social application, such applications are seldom related with primary screen before. But with the advanced capabilities of the second screen devices, it's very easy to deploy social networking according to media contents users are watching, where they can make new relationships with other users who are watching or are interested with the same media content, or share the media they are watching to their friends.
6) Content persistency, is another concept that is not implemented in conventional primary screen scenario. A typical user scenario of content persistency is, the user is watching media content on primary screen, now he/she has to leave, the second screen device records the playing status of the media content, so that the user can resume playing the same media content anyway else with the information stored in the second screen device. Such functions are not applicable without the invented second screen method and system.

To further understand the details of the present invention, the definitions of some processing are necessary which are as follows:

Extract/Generate: to obtain and collect characteristics or fingerprints of media contents via several extraction algorithms.
Register/Ingest: to register those extracted fingerprints together with extra information of the media content into the database where fingerprints of master media contents are stored and indexed.
Query/Match/Identify: to identify requested fingerprints of a media content by matching from all registered fingerprints of master contents stored in the database, via advanced and optimized fingerprint matching algorithm.

In summary, system and method for interactive second screen comprise:

A system for interactive second screen comprises the following sub-systems:
a) Sub-system capturing audio, video or image information from a primary screen via sensors built with secondary screen device,
b) Sub-system extracting and collecting VDNA (Video DNA) fingerprints of captured media content in the aforementioned secondary screen device,
c) Sub-system sending the aforementioned extracted fingerprints along with other information such as metadata, user's location, etc to a content and identification server via Internet or mobile networks,
d) Sub-system providing content-aware information or resources back to the aforementioned secondary screen device, and
e) Sub-system providing user interaction with the aforementioned content-aware information and resources.

The aforementioned dynamic and adaptive VDNA fingerprint extraction comprises:
a) sampling a media frame as an image,
b) dynamically dividing an input image into certain variable amount of equally sized squares,
c) computing average value of RGB (Red, Green and Blue) values from each pixel in each square,
d) The VDNA fingerprint of the image being a two dimensional vector of the values from all divided squares, and
e) The VDNA fingerprint is used to synchronize with the media frame including master frame and sample frame.

The aforementioned second screen is a device used to display additional information of the aforementioned media content displayed on the aforementioned primary screen.

The aforementioned additional information can be anything relative to the aforementioned media content such as advertisements, games, contact information, relevant or promoted contents and so on, and such the aforementioned additional information is controlled by content providers from server side.

The aforementioned second screen usually has no physical relationship with the aforementioned primary screen device.

The aforementioned second screen device uses sensors to perceive the aforementioned media contents that are playing on the aforementioned primary screen.

The aforementioned sensors can be those on the aforementioned second screen device such as built-in cameras or microphones, or those on other devices connecting to the aforementioned second screen device to help capturing content from the aforementioned primary screen.

The aforementioned extracting and collecting VDNA fingerprints is performed on the aforementioned second screen device while capturing content from the aforementioned primary screen.

The aforementioned second screen devices connect with a server through various networks including Internet, GSM/CDMA (global service of mobile communications/code division multiplex access) networks, television networks and so on.

The aforementioned identification server and content server can be in a same system providing surrounding information and real-time interactive resources as soon as the aforementioned content is identified.

The aforementioned second screen device can have interaction with the aforementioned content and identification server or other servers.

A method for interactive second screen comprises the following steps:
a) capturing audio, video or image information from a primary screen via sensors built with a secondary screen device,
b) extracting and collecting VDNA (Video DNA) fingerprints of captured media content in the aforementioned secondary screen device,
c) sending the aforementioned extracted fingerprints along with other information such as metadata, user's location, etc to a content and identification server via Internet or mobile networks,
d) providing content-aware information or resources back to the aforementioned secondary screen device, and
e) providing user interaction with the aforementioned content-aware information and resources for end users.

The aforementioned dynamic and adaptive VDNA fingerprint extraction comprises:
a) sampling a media frame as an image,
b) dynamically dividing an input image into certain variable amount of equally sized squares,
c) computing average value of RGB (Red, Green and Blue) values from each pixel in each square,
d) The VDNA fingerprint of the image being a two dimensional vector of the values from all divided squares, and

The VDNA fingerprint is used to synchronize with the media frame including master frame and sample frame.

The aforementioned second screen device may start process automatically by the aforementioned sensors and keep working continuously, or trigger manually by users.

The aforementioned captured media content can be irreversibly extracted to the aforementioned VDNA fingerprints and sent to the aforementioned identification server, wherein sending the aforementioned VDNA fingerprints instead of captured content data has the advantage of greatly saving transmission bandwidth and protecting user privacy.

The aforementioned identification server starts identification process as soon as enough the aforementioned VDNA fingerprints are received from the aforementioned second screen device.

The content to be played on the aforementioned second screen may be sent by the aforementioned identification server as soon as the aforementioned content is identified, or the aforementioned content is pulled by the aforementioned second screen device after receiving result from the aforementioned identification server.

The aforementioned content to play on the aforementioned second screen is set by content owner or person who has rights to set the aforementioned content.

The aforementioned end users can select preferable type of the aforementioned content to be displayed on the aforementioned second screen.

The aforementioned sensor can be turned off after working correctly and the aforementioned end user can determine when to synchronize the aforementioned second screen with the aforementioned primary screen.

The aforementioned media content can be synchronized between the aforementioned primary screen and the aforementioned second screen, and as soon as the aforementioned content is synchronized, the aforementioned second screen can turn off the aforementioned sensor, and the aforementioned contents on both the aforementioned screens can play synchronously, and while the aforementioned content on the aforementioned primary screen may change at unknown time, the aforementioned second screen can synchronize with the aforementioned primary screen at any time as soon as the aforementioned sensor is available.

The method and system of the present invention are based on the proprietary architecture of the aforementioned VDNA® and VDDB® platforms, developed by Vobile, Inc, Santa Clara, Calif.

Different from U.S. Pat. No. 8,009,861, Publication No. 2007-0253594 by Lu, et al

The VDNA fingerprint extraction in the present invention is unique and totally different from the prior art by U.S. Pat. No. 8,009,861, PUBLICATION NO. 2007-0253594 by LU, et al (hereafter called LU_594).

COUNT 1: The prior art LU_594 is totally different from the dynamic VDNA fingerprint extraction in the present invention because:

In Prior Art LU_594:

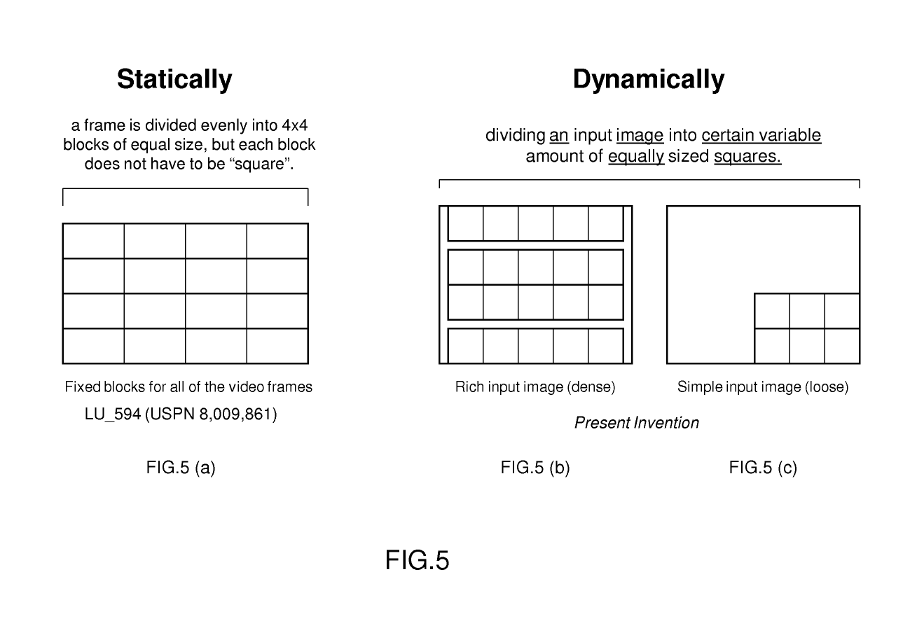

“a frame is divided evenly into 4×4 or 2×2 blocks of equal size. But each block does not have to be “square”. Hence, the number of blocks and location of blocks are fixed, so it is impossible to adjust the block density according to the variation of different video frame's content characteristics. Therefore, it is a static method (see FIG. 5 (a)).

In the present invention and its parent application:

“dividing an input image into certain amount of equally sized squares” which means that the input image is dynamically divided into variable amount of equally sized squares.

For example and for explanation:
for rich image, it relates to large amount of equally sized squares;
for simple image, it relates to small amount of equally sized squares.

Hence, the number of squares and location of squares can be dynamically adjusted to adapt to the variation of different video image's content characteristics (see FIGS. 5 (b) and (c)).

Furthermore, the aforementioned dynamic VDNA fingerprint extraction can be time-based (between frames) or space-based (within frame content itself), and so different VDNA fingerprints are extracted for master frames and sample frames.

The VDNA fingerprint extraction of the sample frame is dynamic and the extracted VDNA fingerprint in the first matching is the most accurate one which is used to quickly determine the original frame, namely, the “sync (synchronization)” success. In contrast, the extracted VDNA fingerprint during the video playing is of low accuracy which is used to trace the “sync” status. In other words, the high accurate VDNA fingerprint is used to match and search original frame “sync” while the low accurate VDNA fingerprint is used to trace “sync lock”. The former requires large amount of data and computing while the later requires less data and computing.

Once the “sync” is locked, the VDNA fingerprint of sample frame will automatically switch to low accurate mode to save bandwidth and computing resources.

But, if the matching performance is too low which is called “out of sync”, it can immediately increase the VDNA fingerprint accuracy which adaptively executes the “re-sync” process with the high accurate VDNA fingerprint extraction.

Therefore, the aforementioned VDNA fingerprint is used to synchronize with the media contents or media frames including master frames and sample frames.

To further reduce data bandwidth and computing consumption, the low accurate VDNA fingerprint utilizes time segmentation and multiple-frame overlapping.

COUNT 2: the processing is different between LU_594 and the present invention.

In Prior Art LU_594:

“B.sub.i is the mean pixel value of the i-th block”; “Compare and rank the value of B.sub.i among the blocks and assign the ordinal rank to each block” and “Compare and rank the value of D.sub.i among the frames in the group and assign the ordinal rank to each frame”.

Here, the original value in each block has been lost after “compare and rank” processing.

After “compare and rank” processing, it can save storage space and simplify computing, but lose match quality.

In the present invention and its parent application:

“compute average value of the RGB values from each pixel in each square” and “VDNA fingerprint of this image is the 2 dimensional vector of the values from all divided squares”.

Here, without any “compare and rank” processing, it greatly increases the match quality based on original values from each pixel in each square.

Therefore, the processing and process are totally different between prior art LU_594 and the present/parent application.

### COUNT 3:

Prior art LU_594 is limited to “fingerprinting video”, but the present invention is limited to “extracting fingerprint from input media content” wherein said media content can be video, image or audio, etc.

In conclusion, the prior art LU_594 is totally different and completely unrelated to the present and its parent applications.

### COUNT 4:

The present invention is focused on the following features which are not covered in the prior art LU_594:
a) Extracting and collecting VDNA fingerprints of media contents playing on various network-enabled terminals including Internet browsers, mobile devices, tablets, smart TVs (television) and so on.
b) Extracted fingerprints are very small in size compared to the media content, which allows transferring fingerprints over a network possible and the design of VDNA fingerprints is very compact, so that it is feasible to transfer over mobile networks.
c) Extracting VDNA fingerprints of the media content while it's playing and these two actions are running in parallel and independently.
d) There are various levels of VDNA extraction algorithm. In more complex version of the VDNA extraction algorithm, other factors such as brightness, alpha value of the image, image rotation, clipping or flipping of the screen, or even audio fingerprint values will be considered.

In addition, the “Identify” mode can be extended to the “Follow” mode to increase the identification accuracy. This is also a very important disclosure in the present invention.

The method and system of the present invention are not meant to be limited to the aforementioned experiment, and the subsequent specific description utilization and explanation of certain characteristics previously recited as being characteristics of this experiment are not intended to be limited to such techniques.

Many modifications and other embodiments of the present invention set forth herein will come to mind to one ordinary skilled in the art to which the present invention pertains having the benefit of the teachings presented in the foregoing descriptions. Therefore, it is to be understood that the present invention is not to he limited to the specific examples of the embodiments disclosed and that modifications, variations, changes and other embodiments are intended to be included within the scope of the appended claims. Although specific terms are employed herein, they are used in a generic and descriptive sense only and not for purposes of limitation.

What is claimed:

1. A system for interactive second screen by dynamic VDNA (Video DNA) fingerprint extraction, said system comprising:
a) Sub-system capturing audio, video or image information from a primary screen via sensors built with secondary screen device,
b) Sub-system extracting and collecting VDNA fingerprints of captured media content in said secondary screen device,
c) Sub-system sending said extracted fingerprints along with other information such as metadata, user's location, etc to a content and identification server via Internet or mobile networks,
d) Sub-system providing content-aware information or resources back to said secondary screen device, and
e) Sub-system providing user interaction with said content-aware information and resources,
wherein said dynamic VDNA fingerprint extraction comprises:
a) sampling a media frame as an image,
b) dynamically dividing an input image into certain variable amount of equally sized squares,
c) computing average value of RGB (Red, Green and Blue) values from each pixel in each said square,
d) said VDNA fingerprint of said image being a two dimensional vector of the values from all divided squares, and
e) said VDNA fingerprint is used to synchronize with said media frame including master frame and sample frame.

2. The system as recited in claim 1, wherein said second screen is a device used to display additional information of said media content displayed on said primary screen.

3. The system as recited in claim 2, wherein said additional information can be anything relative to said media content such as advertisements, games, contact information, relevant or promoted contents and so on, and such said additional information is controlled by content providers from server side.

4. The system as recited in claim 1, wherein said second screen usually has no physical relationship with said primary screen device.

5. The system as recited in claim 4, wherein said second screen device uses sensors to perceive said media contents that are playing on said primary screen.

6. The system as recited in claim 5, wherein said sensors can be those on said second screen device such as built-in cameras or microphones, or those on other devices connecting to said second screen device to help capturing content from said primary screen.

7. The system as recited in claim 1, wherein said extracting and collecting VDNA fingerprints is performed on said second screen device while capturing content from said primary screen.

8. The system as recited in claim 1, wherein said second screen devices connect with a server through various networks including Internet, GSM/CDMA (global service of mobile communications/code division multiplex access) networks, television networks and so on.

9. The system as recited in claim 1, wherein said identification server and content server can be in a same system providing surrounding information and real-time interactive resources as soon as said content is identified.

10. The system as recited in claim 1, wherein said second screen device can have interaction with said content and identification server or other servers.

11. A method for interactive second screen by dynamic VDNA (Video DNA) fingerprint extraction, said method comprising:
a) capturing audio, video or image information from a primary screen via sensors built with a secondary screen device,
b) extracting and collecting VDNA fingerprints of captured media content in said secondary screen device,
c) sending said extracted fingerprints along with other information such as metadata, user's location, etc to a content and identification server via Internet or mobile networks,
d) providing content-aware information or resources back to said secondary screen device, and
e) providing user interaction with said content-aware information and resources for end users,
wherein said dynamic VDNA fingerprint extraction comprises:
a) sampling a media frame as an image,
b) dynamically dividing an input image into certain variable amount of equally sized squares,
c) computing average value of RGB (Red, Green and Blue) values from each pixel in each said square,
d) said VDNA fingerprint of said image being a two dimensional vector of the values from all divided squares, and
said VDNA fingerprint is used to synchronize with said media frame including master frame and sample frame.

12. The method as recited in claim 11, wherein said second screen device may start process automatically by said sensors and keep working continuously, or trigger manually by users.

13. The method as recited in claim 11, wherein said captured media content can be irreversibly extracted to said VDNA fingerprints and sent to said identification server, wherein sending said VDNA fingerprints instead of captured content data has the advantage of greatly saving transmission bandwidth and protecting user privacy.

14. The method as recited in claim 11, wherein said identification server starts identification process as soon as enough said VDNA fingerprints are received from said second screen device.

15. The method as recited in claim 11, wherein content to be played on said second screen may be sent by said identification server as soon as said content is identified, or said content is pulled by said second screen device after receiving result from said identification server.

16. The method as recited in claim 15, wherein said content to play on said second screen is set by content owner or people who has rights to set said content.

17. The method as recited in claim 11, wherein said end users can select preferable type of said content to be displayed on said second screen.

18. The method as recited in claim 11, wherein said sensor can be turned off after working correctly and said end user can determine when to synchronize said second screen with said primary screen.

19. The method as recited in claim 11, wherein said media content can be synchronized between said primary screen and said second screen, and as soon as said content is synchronized, said second screen can turn off said sensor, and said contents on both said screens can play synchronously, and while said content on said primary screen may change at unknown time, said second screen can synchronize with said primary screen at any time as soon as said sensor is available.
